(19) United States
(12) Patent Application Publication
(10) Pub. No.: US 2017/0341391 A1
(43) Pub. Date: Nov. 30, 2017

(54) LIQUID DISCHARGE HEAD AND LIQUID DISCHARGE APPARATUS

(71) Applicant: CANON KABUSHIKI KAISHA, Tokyo (JP)

(72) Inventors: Tatsurou Mori, Yokohama-shi (JP); Shingo Okushima, Kawasaki-shi (JP); Satoshi Kimura, Kawasaki-shi (JP); Satoshi Oikawa, Yokohama-shi (JP)

(21) Appl. No.: 15/603,905

(22) Filed: May 24, 2017

(30) Foreign Application Priority Data
May 26, 2016 (JP) 2016-105156

(51) Int. Cl. B41J 2/14

(52) U.S. Cl. CPC B41J 2/1433

(57) ABSTRACT

A liquid discharge head includes a recording element board including a discharge port for discharging liquid, a channel member including a channel for supplying the liquid to the recording element board, and supporting the recording element board, a first supporting portion fixed to the channel member on one end side of the channel member in a longitudinal direction, and a second supporting portion fixed to the channel member on another end side of the channel member in the longitudinal direction, and a first member supported by the first supporting portion and the second supporting portion. The first supporting portion supports the first member in such a manner that the first member is movable in the longitudinal direction relative to the first supporting portion.

### BACKGROUND OF THE INVENTION

### Field of the Invention

The present disclosure relates to a liquid discharge head for discharging liquid, such as ink, and a liquid discharge apparatus including the liquid discharge head.

### Description of the Related Art

In recent years, liquid discharge apparatuses have been used not only for printing at home, but also for commercial uses, such as business and retail photos, or for industrial uses, such as electronic circuit drawing and panel displays. The uses of the liquid discharge apparatuses have been thus spreading. The liquid discharge apparatuses used in printing for business are required to perform high-speed printing. To meet this requirement, the specification of U.S. Pat. No. 7,090,336 discusses a line-type head including a plurality of liquid discharge heads arranged in the width direction of a record medium, and has a length longer than the width of the record medium.

A line-type liquid discharge head includes a wide variety of members. In this type of liquid discharge head, when a member thermally expands, deformation (such as warpage, distortion, and twisting) of the liquid discharge head occurs due to a difference in linear expansion coefficient between the members. The deformation of the liquid discharge head is greater as components are larger and longer. This may reduce the positional accuracy of a discharge module in the liquid discharge head, causing the landing position of a droplet to deviate from a desired position and degrading image quality.

### SUMMARY OF THE INVENTION

The present disclosure is directed to a technique for reducing the influence of difference in linear expansion coefficient between members to provide a liquid discharge head capable of forming a high-quality image.

According to an aspect of the present disclosure, a liquid discharge head includes a recording element board including a discharge port for discharging liquid, a channel member including a channel for supply of the liquid to the recording element board, and supporting the recording element board, a first supporting portion fixed to the channel member on one end side of the channel member in a longitudinal direction, a second supporting portion fixed to the channel member on other end side of the channel member in the longitudinal direction, and a first member supported by the first supporting portion and the second supporting portion. The first supporting portion supports the first member in such a manner that the first member is movable in the longitudinal direction relative to the first supporting portion.

Further features of the present disclosure will become apparent from the following description of exemplary embodiments with reference to the attached drawings.

### BRIEF DESCRIPTION OF THE DRAWINGS

FIG. 1 is a conceptual diagram of a liquid discharge apparatus according to an exemplary embodiment of the present disclosure.

FIG. 2 is a schematic diagram illustrating a circulation path of ink of the liquid discharge apparatus illustrated in FIG. 1.

FIGS. 3A and 3B each illustrate a perspective view of a liquid discharge head according to an exemplary embodiment of the present disclosure.

FIGS. 4A and 4B each illustrate an exploded perspective view of the liquid discharge head illustrated in FIGS. 3A and 3B.

FIGS. 5A and 5B each illustrate a plan view of a first channel member, and FIGS. 5C to 5E each illustrate a plan view of a second channel member.

FIGS. 6A and 6B are a perspective view and a cross-sectional view, respectively, of a recording element board and an ink channel.

FIGS. 7A and 7B are a perspective view and an exploded perspective view, respectively, of a discharge module.

FIGS. 8A to 8D each illustrate a plan view of the recording element board.

FIG. 9 is an enlarged view of an adjoining portion between two recording element boards.

FIGS. 10A and 10B are diagrams each illustrating a supporting portion, a holding member, and an electric wiring board.

FIGS. 11A and 11B are diagrams illustrating a modification example of a configuration illustrated in FIGS. 10A and 10B.

FIGS. 12A and 12B are diagrams illustrating another modification example of the configuration illustrated in FIGS. 10A and 10B.

FIGS. 13A and 13B are diagrams illustrating another modification example of the configuration illustrated in FIGS. 10A and 10B.

### DESCRIPTION OF THE EMBODIMENTS

Exemplary embodiments of the present disclosure will be described in detail below with reference to the accompanying drawings. The exemplary embodiments to be described below are not intended to limit the scope of the disclosure. A liquid discharge head according to an exemplary embodiment adopts a thermal system in which ink is discharged by generating bubbles with a heating element. The present disclosure is also applicable to liquid discharge heads adopting other various types of liquid discharging system, such as a piezo system. The liquid discharge head according to an exemplary embodiment of the present disclosure discharges ink, but the present disclosure is also applicable to liquid discharge heads for discharging other kinds of liquid.

In the exemplary embodiments, the ink is caused to flow in a pressure chamber, and ink that is not discharged from a discharge port is collected from the pressure chamber. To that end, ink is circulated between an ink tank and the liquid discharge head. Alternatively, two tanks may be separately provided upstream and downstream of the liquid discharge head. In such a case, the ink in the pressure chamber may be caused to flow by the ink being caused to flow from one of the tanks to the other, without circulation of the ink.

The liquid discharge head according to each of the exemplary embodiments is a line-type head having a length corresponding to the width of a recording medium. The present disclosure is also applicable to a serial-type liquid discharge head that performs recording on a recording medium while scanning. The serial-type liquid discharge head is configured to include, for example, one recording element board for black ink and one recording element board for color ink. However, the configuration is not limited thereto, and other configurations may be adopted. For example, there may be adopted a configuration in which some recording element boards are arranged to overlap discharge ports in a discharge port array direction, a line head having a length shorter than the width of a recording medium is provided, and causes the line head to traverse across the recording medium.

In the following description, the width direction of a recording medium may be referred to as a first direction X, and a conveyance direction for conveying the recording medium may be referred to as a second direction Y. The first direction X and the second direction Y are orthogonal to each other. The first direction X matches the longitudinal direction of a second channel member 60 (described below). The present disclosure is suitably applicable to a line head, but is also applicable to a liquid discharge head mounted on a carriage that moves in the width direction of a recording medium. In such a case, the first direction X may match a conveyance direction for conveying a recording medium, and the second direction Y may match the width direction of a recording medium. A direction in which discharge ports are arranged or a direction in which a discharge port array extends is referred to as a discharge port array direction. In the present exemplary embodiments, the discharge port array direction is slightly inclined relative to the first direction X, but may match the first direction X.

### (Description of Liquid Discharge Apparatus)

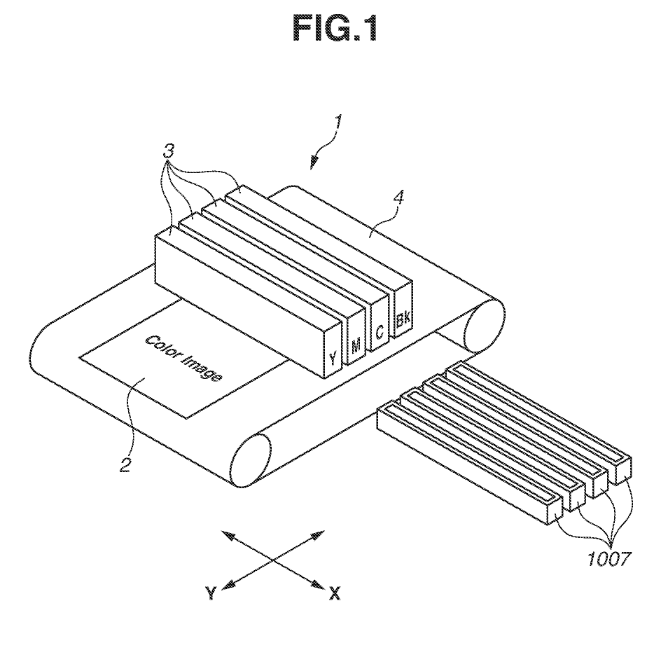

FIG. 1 illustrates a conceptual diagram of a liquid discharge apparatus according to an exemplary embodiment of the present disclosure. A liquid discharge apparatus 1 includes four liquid discharge heads 3 for single color. The four liquid discharge heads each correspond to a different one of CMYK (cyan, magenta, yellow, and black) inks. The liquid discharge apparatus 1 performs full color recording on a recording medium 2 which is conveyed in the second direction Y with a conveyance means 4. The four liquid discharge heads 3 are arranged along the second direction Y. The liquid discharge heads 3 each have twenty discharge port arrays. The liquid discharge heads 3 can each perform remarkably high-speed recording, by distributing recording data to the discharge port arrays and recording the data. If the ink is not discharged from one of discharge ports, the ink is discharged for interpolation from a discharge port at the same position in the first direction X in another discharge port array. This configuration improves the reliability of printing, and therefore the liquid discharge apparatus 1 is suitable for commercial printing. The liquid discharge heads 3 of the present exemplary embodiment each have a width of 500 mm or more in the first direction X.

### (Description of Ink Circulation Path)

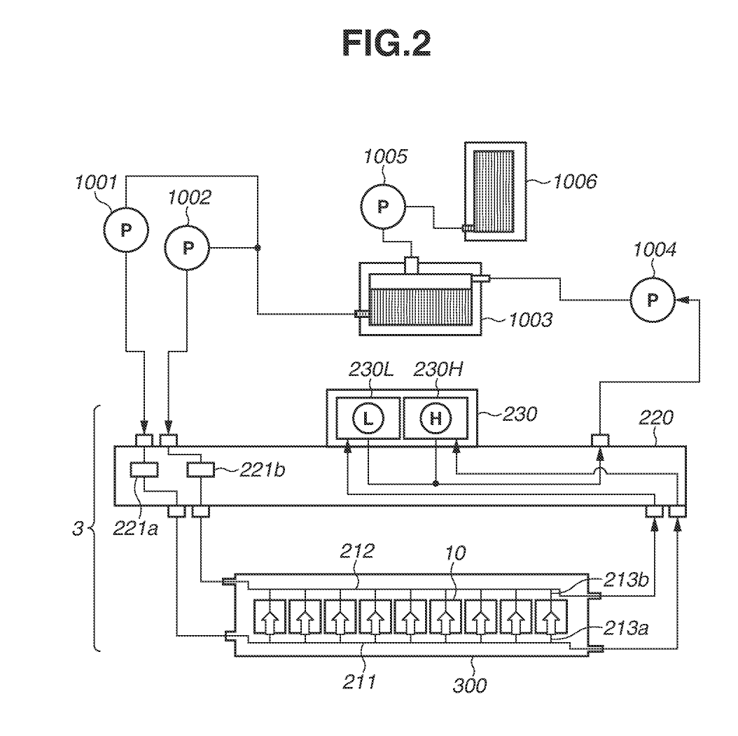

FIG. 2 is a schematic diagram illustrating an ink circulation path of the liquid discharge apparatus 1. Here, FIG. 2 illustrates only an ink circulation path for one of the liquid discharge heads 3, and the other liquid discharge heads 3 each have a similar circulation path. In the present exemplary embodiment, a pressure chamber 23 includes an energy generating element 15 for generating energy to be used for discharge of the liquid. The pressure chamber 23 is configured so that the liquid in the pressure chamber 23 circulates between the pressure chamber 23 and the outside of the pressure chamber 23, which will be described below.

A first circulation pump (high-pressure side) 1001 and a first circulation pump (low-pressure side) 1002 are disposed upstream of the liquid discharge head 3. The first circulation pump (high-pressure side) 1001 is connected to a common supply channel 211 via a filter 221a. The first circulation pump (low-pressure side) 1002 is connected to a common collecting channel 212 via a filter 221b. A negative pressure control unit 230 is disposed downstream of the liquid discharge head 3. A buffer tank 1003 is disposed downstream of the negative pressure control unit 230. The buffer tank 1003 is connected to the first circulation pumps 1001 and 1002. The buffer tank 1003 is also connected to an ink tank 1006 serving as a liquid container, via a replenishment pump 1005. This configuration forms a circulation path in which the ink flows into the liquid discharge head 3, flows out from the liquid discharge head 3, and flows into the liquid discharge head 3 again.

The negative pressure control unit 230 includes two pressure regulation mechanisms (a negative pressure control unit 230H and a negative pressure control unit 230L) in each of which a control pressure different from each other is set. The negative pressure control unit 230H set to the high-pressure side is connected to the common supply channel 211 in a liquid discharge unit 300, via a liquid supply unit 220. The negative pressure control unit 230L set to the low-pressure side is connected to the common collecting channel 212 in the liquid discharge unit 300, via the liquid supply unit 220. The two negative pressure control units 230H and 230L keep the pressure of the common supply channel 211 at a relatively higher level than that of the pressure of the common collecting channel 212. This configuration generates a flow (indicated by each of outline arrows in FIG. 2) of the ink from the common supply channel 211 to the common collecting channel 212, via an individual channel 213a, an internal channel of each of recording element boards 10, and an individual channel 213b. The pressure regulation mechanism of the negative pressure control unit 230, which provides a similar effect provided by a back pressure regulator”, controls the pressure on the upstream side thereof to fall in a predetermined fluctuation range centered at a set pressure. Even if a flow rate varies due to a change in recording duty in recording data with the liquid discharge head 3 the negative pressure control unit 230 controls pressure fluctuations on the upstream side (i.e., on the liquid discharge unit 300 side) of the negative pressure control unit 230 to fall within the above-mentioned fluctuation range.

A second circulation pump 1004 operates as a negative pressure source for reducing the pressure on the downstream side of the negative pressure control unit 230. In addition, the second circulation pump 1004 pressurizes the buffer tank 1003. This configuration can suppress influence of a water head pressure of the buffer tank 1003, and thus can increase a range of choices for the layout of the buffer tank 1003 in the liquid discharge apparatus 1. In place of the second circulation pump 1004, for example, a water head tank can be used as appropriate. In such a case, the water head tank is disposed to have a predetermined water head difference relative to the negative pressure control unit 230.

### (Description of Liquid Discharge Head Structure)

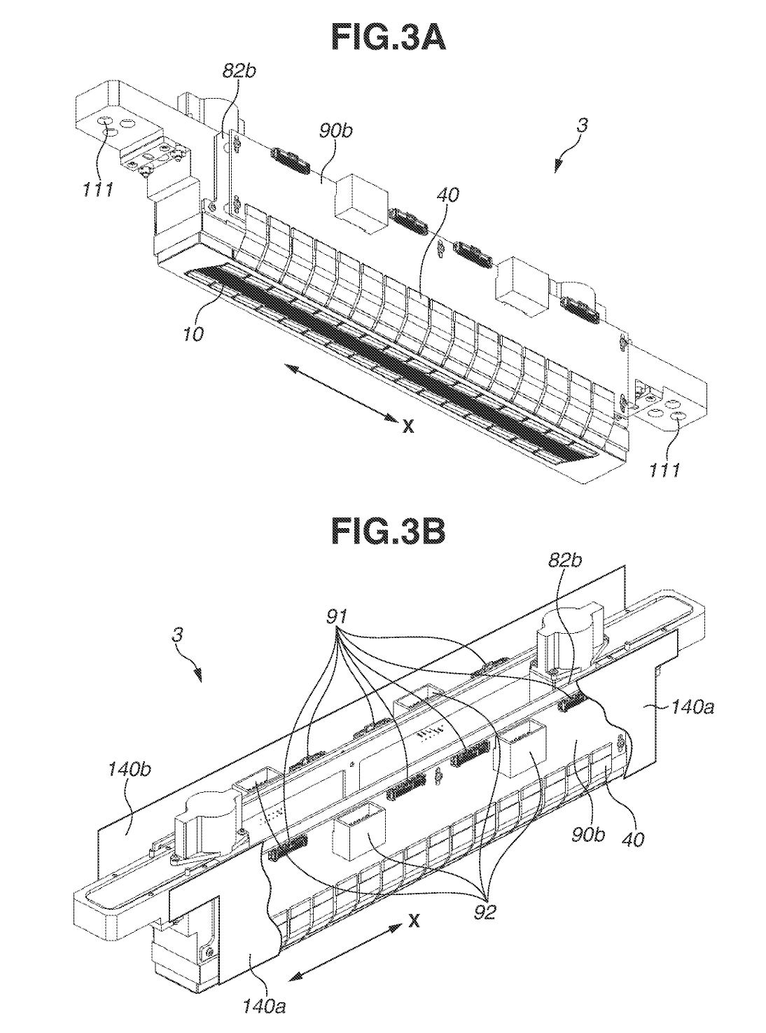

A structure of the liquid discharge head 3 will be described. FIG. 3A is a perspective view of the liquid discharge head 3 according to the present exemplary embodiment when viewed from the discharge port side. FIG. 3B is a perspective view of the liquid discharge head 3 when viewed from the opposite side of the discharge port side. As described above, the liquid discharge head 3 is a line-type recording head employing an ink-jet system and discharges the ink of one color. The liquid discharge head 3 includes the sixteen recording element boards 10 arranged in line along the first direction X. The liquid discharge head 3 includes a liquid connection portion 111, a signal input terminal 91, and a power supply terminal 92. The signal input terminal 91 and the power supply terminal 92 are disposed on both sides of the liquid discharge head 3. This configuration reduces voltage drops and signal transmission delays in a wiring portion of the recording element board 10.

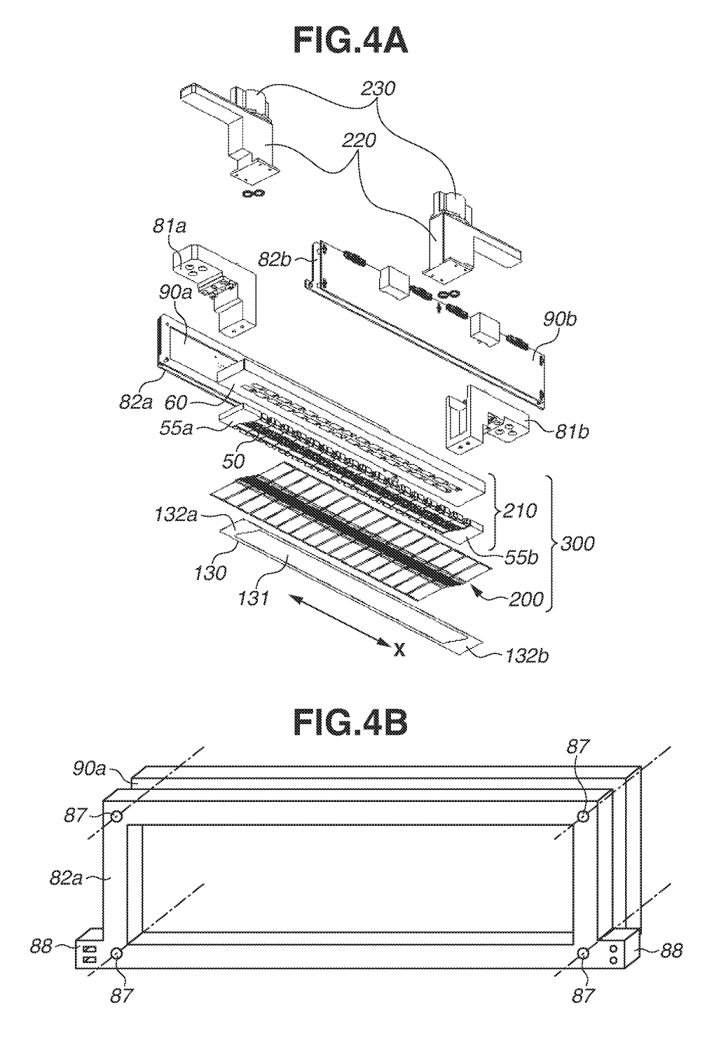

FIG. 4A is an exploded perspective view of the liquid discharge head 3. In FIG. 4A, each component or unit of the liquid discharge head 3 is illustrated, being divided by function. The liquid discharge unit 300 has a channel member 210 and a plurality of discharge modules 200. The channel member 210 includes a first channel member 50 and the second channel member 60 disposed on the first channel member 50. The second channel member 60 includes the common supply channel 211 and the common collecting channel 212. The ink supplied from the liquid supply unit 220 is distributed from the common supply channel 211 of the channel member 210 to each of the discharge modules 200. The ink flowing out from each of the discharge modules 200 returns from the common collecting channel 212 of the channel member 210 to the liquid supply unit 220. The second channel member 60 forms the common supply channel 211 and the common collecting channel 212. The second channel member 60 indirectly supports the recording element board 10, and has the function of increasing the rigidity of the liquid discharge head 3. Accordingly, it is desirable that the second channel member 60 be formed of a material having sufficient corrosion resistance to the ink and high mechanical strength. Examples of this material include stainless steel, titanium, and alumina.

The liquid supply unit 220 including the negative pressure control unit 230 is supported by a first supporting portion 81a and a second supporting portion 81b. The first supporting portion 81a and the second supporting portion 81b support the second channel member 60 by fixing the second channel member 60 near both ends of the second channel member 60 in the longitudinal direction. The first supporting portion 81a and the second supporting portion 81b support, via a first holding member 82a and a second holding member 82b, a first electric wiring board 90a and a second electric wiring board 90b connected to the recording element board 10. The first holding member 82a and the first electric wiring board 90a are disposed on the opposite side of the second holding member 82b and the second electric wiring board 90b, with the second channel member 60 interposed therebetween. The first holding member 82a is supported by a surface of the first supporting portion 81a and a surface of the second supporting portion 81b. These surfaces face the same direction, in other words, the surfaces are positioned within a plane in which the first holding member 82a extends. The second holding member 82b is supported by the opposite surfaces of the surfaces, of the first supporting portion 81a and the second supporting portion 81b, supporting the first holding member 82a.

The first electric wiring board 90a, the second electric wiring board 90b, the first holding member 82a, and the second holding member 82b are long members provided in common to the plurality of discharge modules 200. These long members extend in the longitudinal direction of the second channel member 60, i.e., in the first direction X. In the present exemplary embodiment, the first holding member 82a is a first member supported by the first supporting portion 81a and the second supporting portion 81b. The second holding member 82b is a second member supported by the first supporting portion 81a and the second supporting portion 81b.

FIG. 4B illustrates a perspective view of the first electric wiring board 90a and the first holding member 82a. Although illustration is omitted, the configuration and the positional relationship of the second electric wiring board 90b and the second holding member 82b are similar to those of the first electric wiring board 90a and the first holding member 82a. The first holding member 82a, which is the first member, is a frame-shaped member extending in the first direction X (the longitudinal direction of the second channel member 60) within one plane. The first holding member 82a has substantially the same shape as that of the first electric wiring board 90a. However, a connection portion 88 connected to each of the first supporting portion 81a and the second supporting portion 81b protrudes in the longitudinal direction. At each of the four corners of each of the first holding member 82a and the first electric wiring board 90a, a hole (not illustrated for the first electric wiring board 90a) is provided. The first holding member 82a holds the first electric wiring board 90a with a space therebetween, by using a fixing member (not illustrated) passing through the first electric wiring board 90a and the hole 87. The shape of the first holding member 82a is not limited to a frame, and may be a plate.

The two liquid supply units 220 each include the filter 221a and the filter 221b (see FIG. 2). The negative pressure control unit 230H on the high-pressure side is disposed at one end of the liquid discharge head 3, and the negative pressure control unit 230L on the low-pressure side is disposed at the other end of the liquid discharge head 3. Accordingly, the ink in the common supply channel 211 extending in the first direction X and the ink in the common collecting channel 212 flow in opposite directions. This configuration facilitates heat exchange between the common supply channel 211 and the common collecting channel 212, so that a temperature difference is less likely to occur among the recording element boards 10 provided along the common supply channel 211 and the common collecting channel 212. Accordingly, print (recording) unevenness due to the temperature difference less easily occurs.

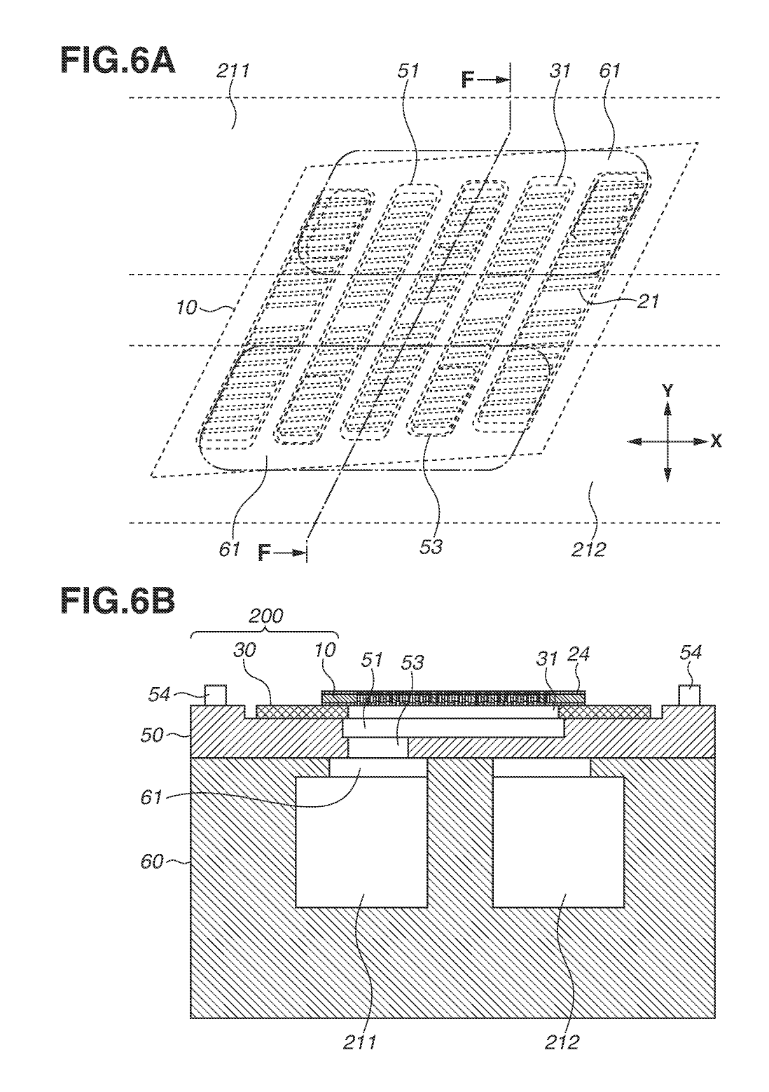

A cover member 130 covers a discharge port formation surface 24 (see FIG. 6B) of the recording element board 10. The cover member 130 has an opening 131 in which the discharge ports are exposed. When the ink is not discharged, a cap member 1007 is brought into contact with the cover member 130 to prevent evaporation of the ink from the discharge ports. In a state where the cap member 1007 is attached to the liquid discharge head 3, a negative pressure is applied with a pump to a space surrounded by the cap member 1007 and the liquid discharge head 3, so that bubbles and thickened ink can be removed from the discharge ports by suction.

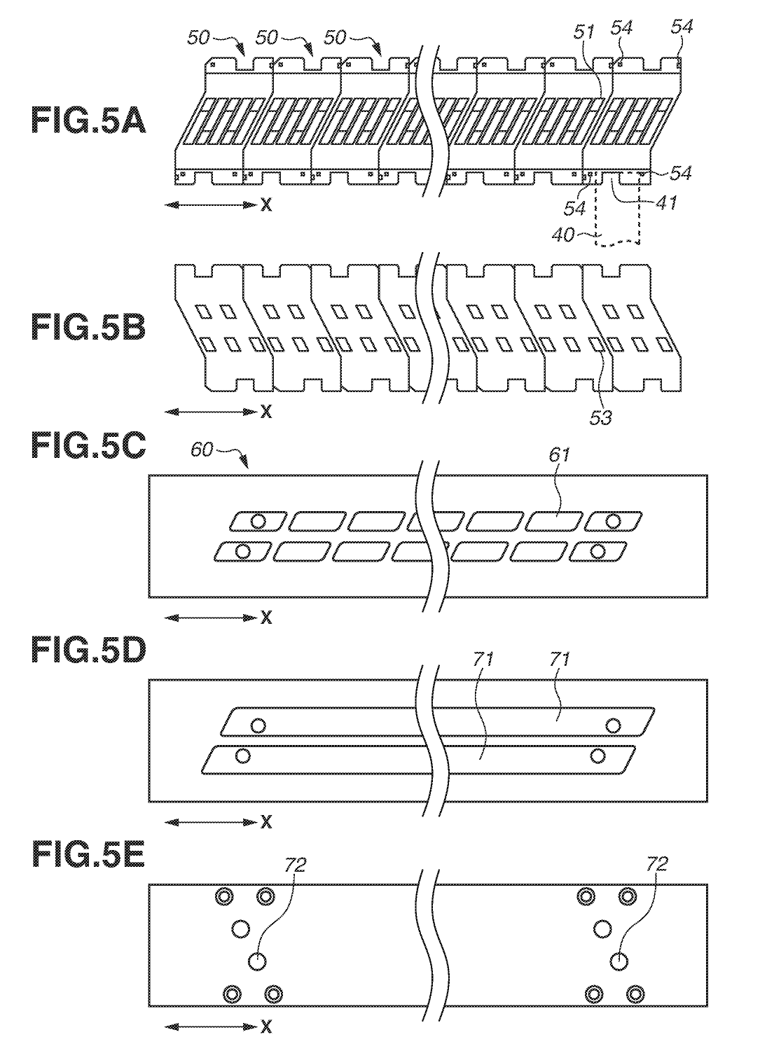

FIG. 5A illustrates a surface, on which the discharge module 200 is to be disposed, of the first channel member 50. FIG. 5B illustrates the back surface, with which the second channel member 60 is brought into contact, of the first channel member 50. A plurality of the first channel members 50 is provided and each of the plurality of first channel members 50 corresponds to a different one of the discharge modules 200. The first channel members 50 are disposed adjacent to one another. The liquid discharge head 3 can have various lengths with the plurality of first channel members 50 being provided. This configuration is particularly suitable for, for example, a liquid discharge head of a relatively long scale corresponding to a B2 or longer size. The first channel member 50 has a communication opening 51 that fluidically communicates with the discharge module 200. The first channel member 50 also has an individual communication opening 53 that fluidically communicates with a communication opening 61 of the second channel member 60.

FIG. 5C illustrates a surface, which is to be brought into contact with the first channel member 50, of the second channel member 60. FIG. 5D illustrates a cross section of a central portion in the thickness direction of the second channel member 60. FIG. 5E illustrates a surface, which is to be brought into contact with the liquid supply unit 220, of the second channel member 60. One of common channels 71 of the second channel member 60 is the common supply channel 211, and the other is the common collecting channel 212. The ink is supplied from one end side to the other end side of the liquid discharge head 3 in the first direction X.

FIG. 6A is a perspective view of the recording element board 10 and the channels of the ink in the channel member 210. A pair of channels, i.e., the common supply channel 211 and the common collecting channel 212 extending in the first direction X, is provided in the channel member 210. The communication opening 61 of the second channel member 60 is connected to the communication openings 53 of the corresponding one of the first channel members 50. There is formed a liquid supply channel that runs from a communication opening 72 (see FIG. 5E) of the second channel member 60 to the corresponding communication opening 51 of the first channel member 50 via the common supply channel 211. Similarly, there is formed a liquid supply channel that runs from a communication opening 72 of the second channel member 60 to the corresponding communication opening 51 of the first channel member 50 via the common collecting channel 212.

FIG. 6B illustrates a cross section taken along a line F-F in FIG. 6A. The common supply channel 211 is connected to the discharge module 200, via the communication opening 61, the individual communication opening 53, and the communication opening 51. Although illustration is omitted, the common collecting channel 212 is similarly connected to the discharge module 200. In each of the discharge modules 200 and the recording element board 10, a channel communicating with the respective discharge ports 13 is formed. Part or all of the supplied ink circulates through the discharge ports 13 (the pressure chamber 23) suspending discharge operation. The surface, on which the discharge ports 13 are formed, of the recording element board 10 is the discharge port formation surface 24.

### (Description of Discharge Module)

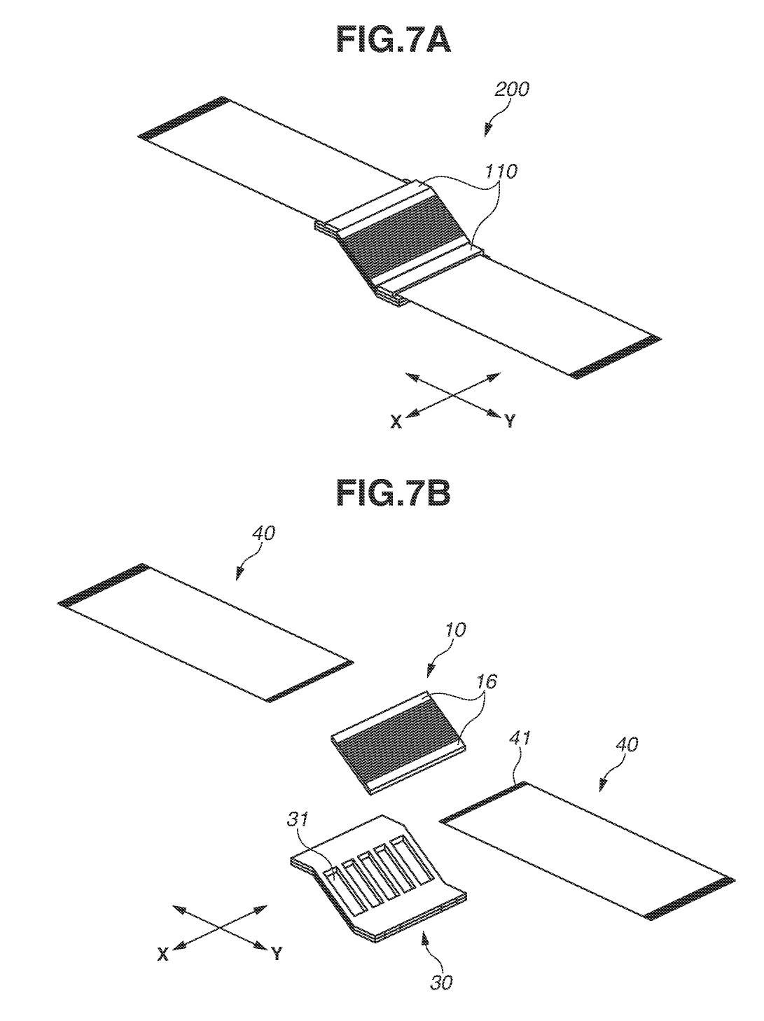

FIG. 7A illustrates a perspective view of the discharge module 200. FIG. 7B illustrates an exploded view of the discharge module 200. A plurality of terminals 16 is disposed along each of both sides (each of long sides of the recording element board 10), which extend in the first direction X, of the recording element board 10. Electric wiring members (flexible printed circuit boards) 40 are each electrically connected to the plurality of terminals 16. A connecting portion between an electric wiring member 40 and the terminals 16 are covered with a sealing agent 110. The two electric wiring members 40 are provided for one recording element board 10. This is because the recording element board 10 has twenty discharge port arrays, and accordingly the number of wires is large. The electric wiring member 40 is provided on each of both sides of the recording element board 10 to shorten a maximum wiring distance from the terminal 16 to the energy generating element 15. This configuration can reduce voltage drops and signal transmission delays which occur in internal wiring. A supporting member 30 supports the recording element board 10. A plurality of liquid communication openings 31 is formed in the supporting member 30. The liquid communication openings 31 each extend while crossing all the discharge port arrays.

### (Description of Structure of Recording Element Board)

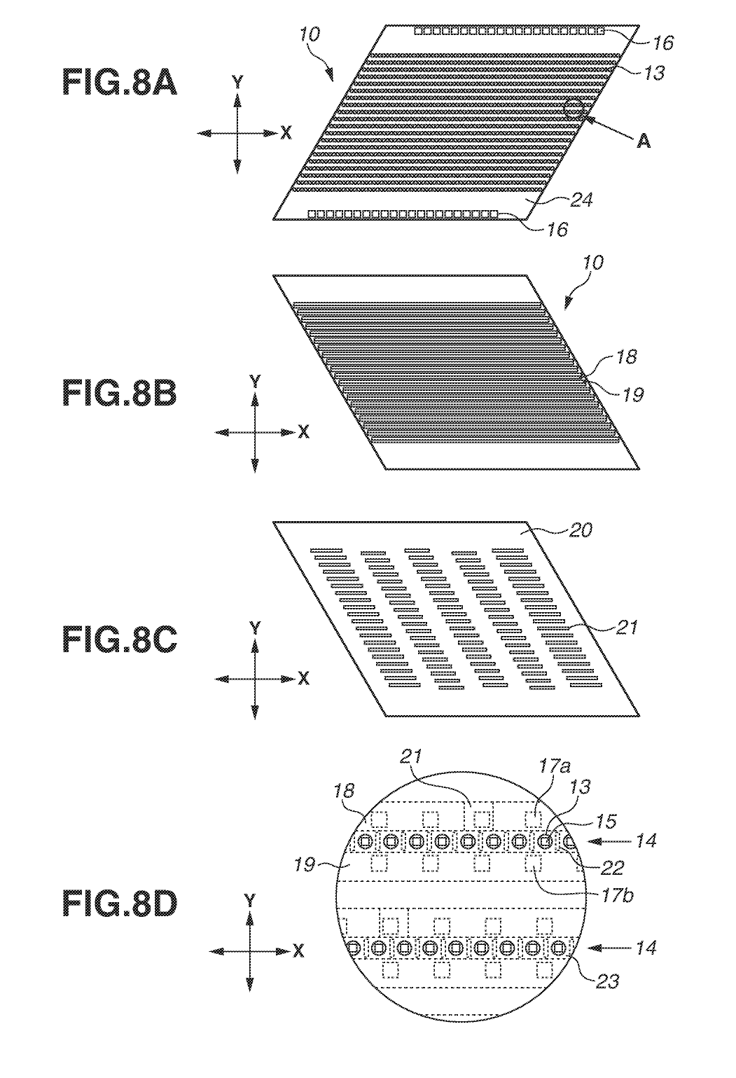

FIG. 8A is a schematic diagram illustrating the discharge port formation surface 24 of the recording element board 10. On the discharge port formation surface 24, the discharge ports 13 are formed. FIG. 8B is a schematic diagram illustrating the back surface of the recording element board 10. FIG. 8C is a schematic diagram illustrating a cover member 20 that covers the recording element board 10. FIG. 8D is an enlarged view of a portion A of the recording element board 10. The portion A is illustrated in FIG. 8A. The recording element board 10 has a substantially parallelogram shape with each corner having a non-right angle. Alternatively, the recording element board 10 may have a rectangle shape, a trapezoid shape, or other shapes. A plurality of discharge port arrays 14 is formed in the recording element board 10. The pressure chamber 23 is sectioned by a partition 22. The pressure chamber 23 includes the energy generating element 15 that generates energy to be used for discharge of the liquid. The energy generating element 15 is disposed to face the discharge port 13. The energy generating element 15 is a heating element that generates thermal energy to cause the ink to bubble. The energy generating element 15 is electrically connected to the terminal 16 by electric wiring (not illustrated) provided on the recording element board 10. The terminal 16 is electrically connected to a control circuit of the liquid discharge apparatus 1, via the first electric wiring board 90a or the second electric wiring board 90b and the electric wiring member 40. On the basis of power and a discharge control signal transmitted from the control circuit, the energy generating element 15 produces heat to boil the ink. The ink is discharged from the discharge port 13 by the force of the bubbles generated by this boiling. A liquid supply path 18 and a liquid collection path 19 are alternately provided along the discharge port array direction, on the back surface of the recording element board 10. The liquid supply path 18 and the liquid collection path 19 are channels extending in the discharge port array direction, and communicate with the discharge port 13 via a supply port 17a and a collection port 17b, respectively. The cover member 20 has a communication opening 21 that communicates with the liquid communication opening 31 of the supporting member 30.

(Description of Positional Relationship between Recording Element Boards)

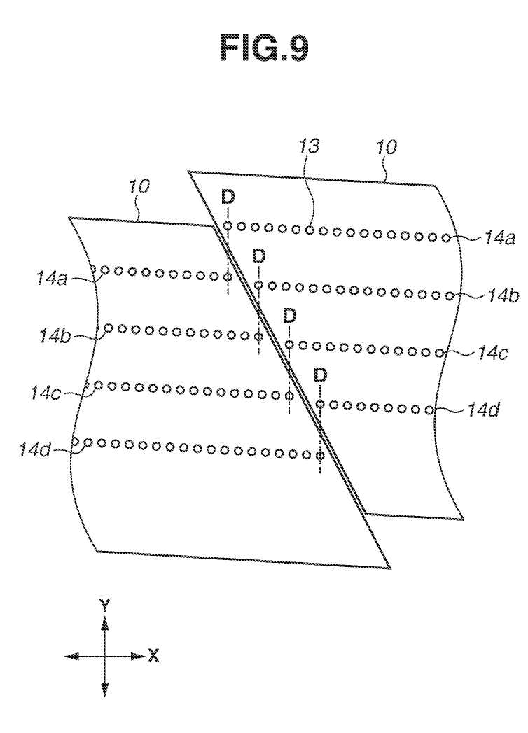

FIG. 9 is an enlarged plan view of part of an adjoining portion between the recording element boards, in the two discharge modules next to each other. A plurality of discharge port arrays 14a to 14d is provided to incline slightly relative to the first direction X. In the adjoining portion between the recording element boards 10, at least one of the discharge ports 13 of each of the recording element boards 10 overlaps another one in the second direction Y. In FIG. 9, two discharge ports 13 on a line D overlap each other. With such an arrangement, even if the position of a recording element board 10 deviates from a predetermined position to some extent, black streaks and white patches on a recorded image can be made less noticeable, by control for driving the overlapping discharge ports 13. In a case where recording is performed by distributing image data to the plurality of discharge port arrays as described in the present exemplary embodiment, the discharge ports 13 may not overlap each other. Black streaks and white patches on a recorded image can be made less noticeable, by distributing image data to the discharge port arrays that vary between the adjacent recording element boards.

### (Configuration of Supporting Portion)

As described above, the first supporting portion 81a and the second supporting portion 81b support the second channel member 60 by fixing the second channel member 60. In addition, in the present exemplary embodiment, the second channel member 60 is different from the first holding member 82a and the second holding member 82b, in terms of linear expansion coefficient. Accordingly, in a case where the first holding member 82a and the second holding member 82b are fixed to the first supporting portion 81a and the second supporting portion 81b in the longitudinal direction (the first direction X), the second channel member 60 and the first holding member 82a as well as the second holding member 82b restrain each other in the longitudinal direction due to the difference in linear expansion coefficient. This may cause deformation (e.g., warpage, distortion, and twisting) of the liquid discharge head 3. This phenomenon becomes more remarkable, as members are larger and longer, as in the line-type head of the present exemplary embodiment. In particular, the influence is large in a recording head having an overall length of 500 or more. Deformation of the liquid discharge head 3 reduces the positional accuracy of the discharge module 200, leading to deviation of the landing position of a discharged droplet, so that the image quality is reduced. To that end, in the present exemplary embodiment, there is provided a configuration for absorbing the longitudinal thermal deformation of the first holding member 82a and the second holding member 82b.

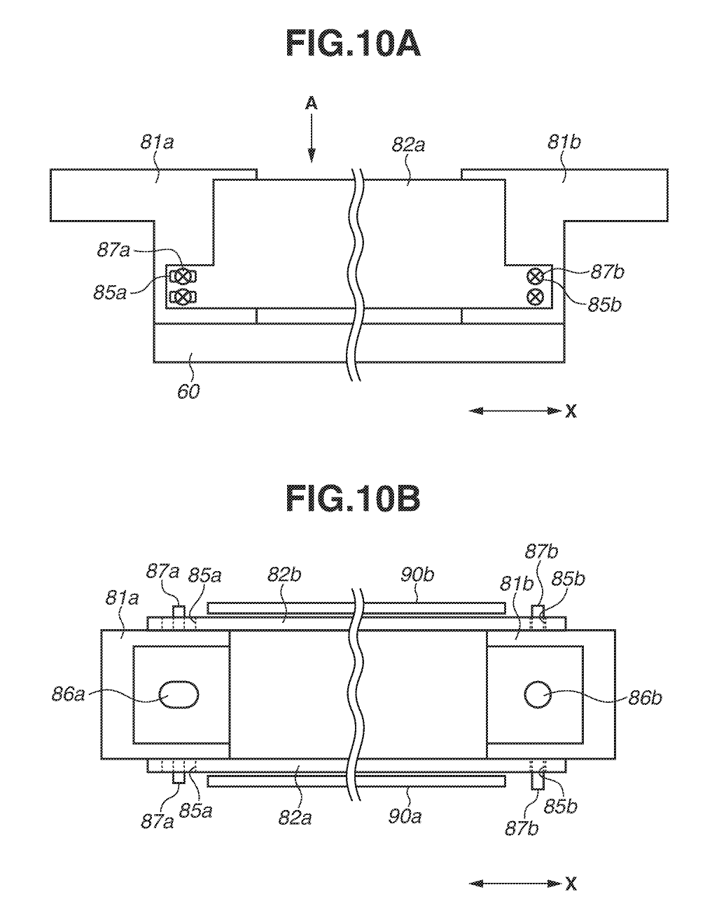

FIG. 10A is a schematic side view of the first supporting portion 81a and the second supporting portion 81b, as well as the first holding member 82a. FIG. 10B is a top view of the same components when viewed from a direction A in FIG. 10A. Although the first holding member 82a will be mainly described below, the second holding member 82b is similar to the first holding member 82a.

As described above, the first electric wiring board 90a is supported by the first supporting portion 81a and the second supporting portion 81b, via the first holding member 82a. The second electric wiring board 90b is supported by the first supporting portion 81a and the second supporting portion 81b, via the second holding member 82b. Two screw holes are provided on one side face of each of the first supporting portion 81a and the second supporting portion 81b. Two screw holes are provided on the other side face, which is the back surface of the one side face. In addition, two elongate holes 85a are provided on one end side of each of the first holding member 82a and the second holding member 82b. Moreover, two round holes 85b are provided on the other end side of each of the first holding member 82a and the second holding member 82b. The screw hole of the first supporting portion 81a and the elongate hole 85a of the first holding member 82a are fixed with a screw 87a. The screw hole of the second supporting portion 81b and the round hole 85b of the first holding member 82a are fixed with a screw 87b. In the present exemplary embodiment, the longitudinal length of the elongate hole 85a is greater than the longitudinal length of the screw 87a, and the tightening force of the screw 87a is thereby adjusted, so that the first holding member 82a is configured to be movable in the longitudinal direction, relative to the first supporting portion 81a. This relative movement can absorb thermal deformation of the first holding member 82a in the longitudinal direction. The diameter of the round hole 85b on the other end side of the first holding member 82a is about the same as the diameter of the screw 87b. This configuration can substantially prevent the first holding member 82a from moving in the longitudinal direction relative to the second supporting portion 81b.

In this way, the first supporting portion 81a supports the first holding member 82a, which is the first member, in such a manner that the first holding member 82a is movable in the longitudinal direction relative to the first supporting portion 81a. In addition, the second supporting portion 81b supports the first holding member 82a, which is the first member, in such a manner that the first holding member 82a is immovable in the longitudinal direction relative to the second supporting portion 81b.

It is desirable that the first holding member 82a be supported by the first supporting portion 81a to be relatively immovable in a direction orthogonal to the longitudinal direction. This configuration can suppress the vibration of the first holding member 82a and thus can increase the reliability of the first electric wiring board 90a. More specifically, the size of the elongate hole 85a in the width direction orthogonal to the longitudinal direction is about the same as the diameter of the screw 87a, so that transverse vibration of the elongate hole 85a of the first holding member 82a can be suppressed. A narrow clearance in the transverse direction of the elongate hole 85a can be formed between the screw 87a and the elongate hole 85a, not to inhibit relative displacement of the first supporting portion 81a in the longitudinal direction. In addition, substantial fixing with the screw 87a can suppress axial vibration of the screw 87a of the first holding member 82a with the screw head (not illustrated). A narrow clearance can be formed also between the head of the screw 87a and the first holding member 82a.

Other than the above-described fixing with the screws, the following configurations can also be applicable. For example, an elongate hole having the major axis extending in the longitudinal direction is provided in the first supporting portion 81a, and a round hole is provided in the second supporting portion 81b. Moreover, a cylindrical protrusion is provided in the first holding member 82a. The cylindrical protrusion is slidably inserted into the elongate hole 85a of the first holding member 82a.

The first supporting portion 81a and the second supporting portion 81b have an elongate hole opening 86a and a round hole opening 86b, respectively. The elongate hole opening 86a and the round hole opening 86b are provided to position the liquid discharge head 3 by mechanically connecting the liquid discharge unit 300 to a carriage (not illustrated) of the liquid discharge apparatus 1. The round hole opening 86b is on the positioning side (reference side) of the carriage of the liquid discharge apparatus 1. In the present exemplary embodiment, the second supporting portion 81b having the round hole opening 86b is provide on the positioning side of the carriage. However, the first supporting portion 81a may be provided on the positioning side of the carriage. Either configuration can reduce the influence of the difference in linear expansion coefficient between the members.

In place of the elongate hole 85a, a round hole having a diameter sufficiently larger than the diameter of the screw 87a can be provided in the first supporting portion 81a. The shape of the hole of the first supporting portion 81a is not limited, as long as the first holding member 82a can move in the longitudinal direction relative to the first supporting portion 81a.

The configuration of establishing a substantially fixed state with the elongate hole 85a and the screw 87a is described above. However, various holding mechanisms can be applicable if the first supporting portion 81a and the first holding member 82a are held to be relatively movable. For example, crimping, or bolt and nut, can be applicable. Fixing between the second supporting portion 81b and the first holding member 82a is not limited to the above-described configurations, and other way such as adhesion can be adopted.

The first supporting portion 81a has the elongate hole 85a on each of both sides, and the second supporting portion 81b has the round hole 85b on each of both sides. However, the first supporting portion 81a and the second supporting portion 81b may each have the elongate hole 85a on one surface and the round hole 85b on the opposite surface of the one surface. In other words, the influence of the difference in linear expansion coefficient can be reduced also by a structure in which thermal expansion of the first holding member 82a and thermal expansion of the second holding member 82b are each absorbed on its opposite side in the longitudinal direction. Moreover, a configuration in which one holding member is provided or a configuration in which three or more holding members are provided may be applicable, without being limited to the configuration in which the two holding members are provided.

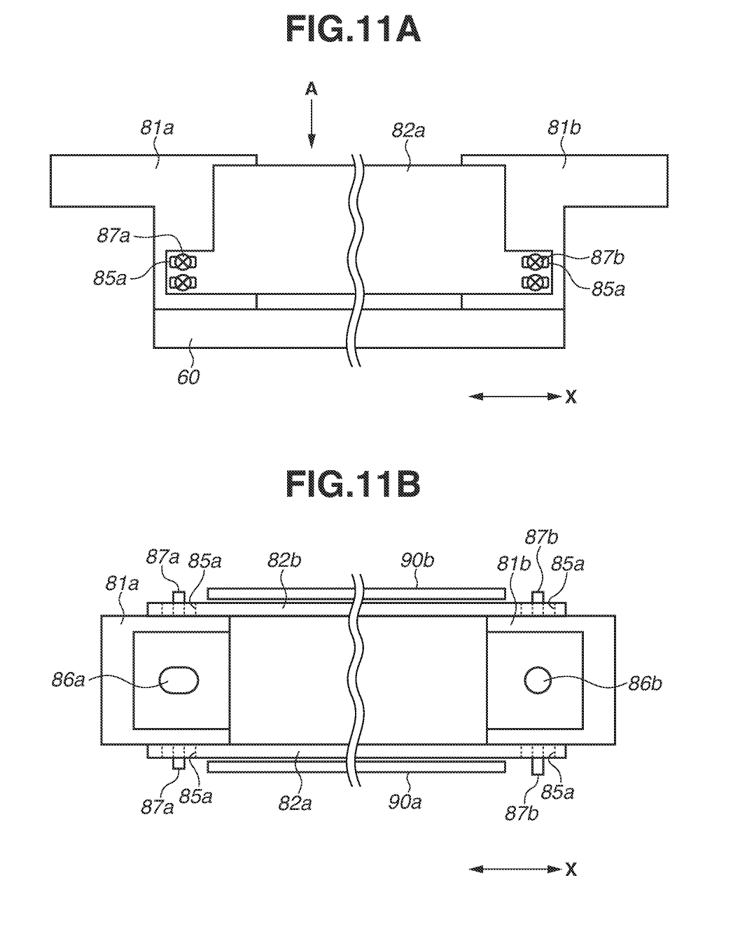

FIGS. 11A and 11B illustrate a modification example of the exemplary embodiment illustrated in FIGS. 10A and 10B. FIG. 11A is a schematic side view of the first supporting portion 81a and the second supporting portion 81b, as well as the first holding member 82a. FIG. 11B is a top view of the same components when viewed from a direction A in FIG. 11A. The first supporting portion 81a and the second supporting portion 81b each have the elongate hole 85a having the major axis extending in the longitudinal direction. The first holding member 82a, which is the first member, has the screw 87a and the screw 87b, which are each slidably inserted into the corresponding one of the elongate holes 85a. As a result, the first supporting portion 81a supports the first holding member 82a in such a manner that the first holding member 82a is movable in the longitudinal direction relative to the first supporting portion 81a. In addition, the second supporting portion 81b supports the first holding member 82a in such a manner that the first holding member 82a is movable in the longitudinal direction relative to the second supporting portion 81b. In the present modification example, the first member is movable in the longitudinal direction relative to both of the first supporting portion 81a and the second supporting portion 81b, and thus can absorb larger relative displacement. In this way, the holding member and each of the supporting members may be substantially fixed to be relatively movable at all points.

### (Other Modification Examples of Supporting Portion)

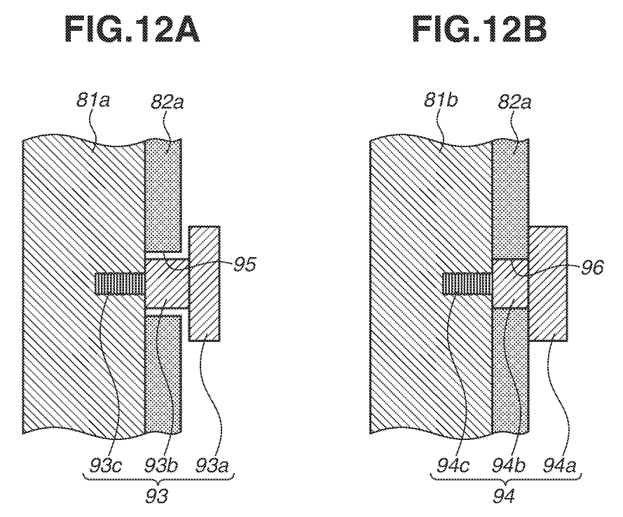

FIGS. 12A and 12B illustrate a modification example with a shoulder screw. FIG. 12A illustrates the first holding member 82a on the first supporting portion 81a side. FIG. 12B illustrates the first holding member 82a on the second supporting portion 81b side. A first round hole 95 and a second round hole 96 are formed in the first holding member 82a. The first round hole 95 is formed on the first supporting portion 81a side, and the second round hole 96 is formed on the second supporting portion 81b side. The shape of each of these holes is not necessarily a circle, and may be a hexagon or a quadrangle, for example.

A first shoulder screw 93 is fixed to the first supporting portion 81a through the first round hole 95. A second shoulder screw 94 is fixed to the second supporting portion 81b through the second round hole 96. The first shoulder screw 93 has a large diameter portion 93a, a small diameter portion 93b, and a threaded portion 93c. The large diameter portion 93a is the head. The threaded portion 93c is screwed into the first supporting portion 81a. The small diameter portion 93b is located between the large diameter portion 93a and the threaded portion 93c, and passes through the first round hole 95. The second shoulder screw 94 has a large diameter portion 94a, a small diameter portion 94b, and a threaded portion 94c. The large diameter portion 94a is the head. The threaded portion 94c is screwed into the second supporting portion 81b. The small diameter portion 94b is located between the large diameter portion 94a and the threaded portion 94c, and passes through the second round hole 96. The small diameter portion 93b of the first shoulder screw 93 forms clearance with the first round hole 95. The small diameter portion 94b of the second shoulder screw 94 is in tight contact with the second round hole 96. In addition, the large diameter portion 93a of the first shoulder screw 93 is away from the first holding member 82a. Meanwhile, the large diameter portion 94a of the second shoulder screw 94 is in tight contact with the first holding member 82a. Such a configuration can be realized by providing the small diameter portions 93b and 94b that vary in height and diameter. In the present modification example as well, thermal deformation of the first holding member 82a can be absorbed between the small diameter portion 93b of the first shoulder screw 93 and the first round hole 95. The second shoulder screw 94 can have a configuration similar to that of the first shoulder screw 93.

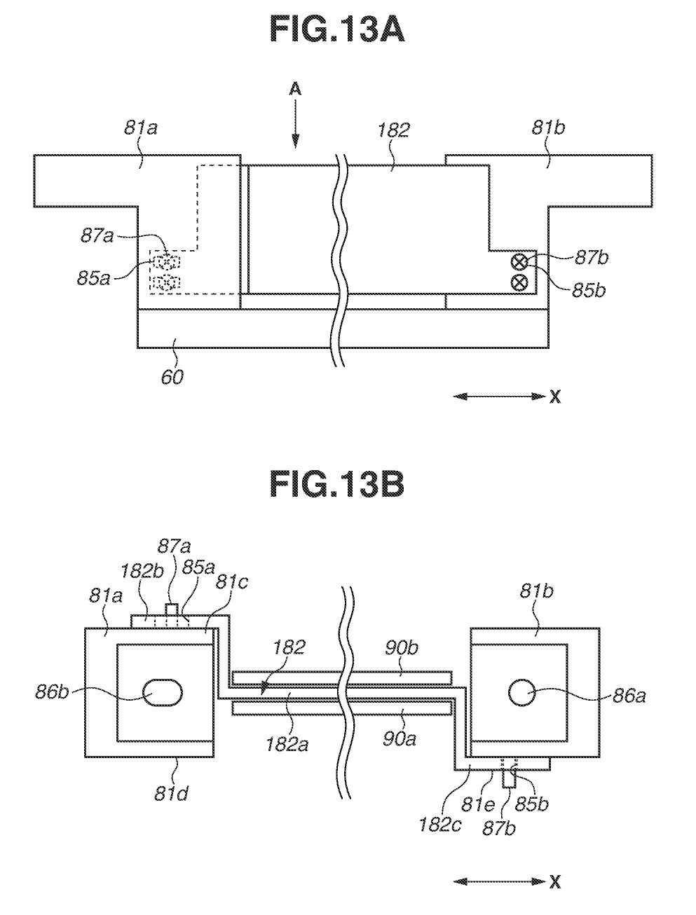

FIG. 13A is a schematic side view of the first supporting portion 81a and the second supporting portion 81b, as well as a holding member 182. FIG. 13B is a top view of the same components when viewed from a direction A in FIG. 13A. FIGS. 13A and 13B illustrate another modification example. In the present modification example, the first electric wiring board 90a and the second electric wiring board 90b are shared with the holding member 182. The holding member 182 serving as the first member has a first portion 182a, a second portion 182b, and a third portion 182c. The first portion 182a extends between the first supporting portion 81a and the second supporting portion 81b. The second portion 182b is supported by a first surface 81c of the first supporting portion 81a. The third portion 182c is supported by a surface 81e of the second supporting portion 81b. The surface 81e faces in the same direction as the direction in which a surface 81d of the second supporting portion 81b faces. The surface 81d is the opposite surface of the first surface 81c.

In the exemplary embodiment illustrated FIGS. 10A, 10B, 11A, and 11B, the first electric wiring board 90a and the second electric wiring board 90b are provided outside the first supporting portion 81a and the second supporting portion 81b. Accordingly, the width of the recording medium in the conveyance direction of the liquid discharge head tends to be large. In the present modification example, the first electric wiring board 90a and the second electric wiring board 90b are provided between the first supporting portion 81a and the second supporting portion 81b, facilitating control of the above-mentioned width. The holding member 182 is connected to the first supporting portion 81a and the second supporting portion 81b with the periphery of each of the first supporting portion 81a and the second supporting portion 81b being bent symmetrically with respect to a point. This configuration increases the rigidity of the holding member 182, suppressing the deformation of the liquid discharge head.

In the above-described exemplary embodiment, the first member and the second member are the first holding member 82a and the second holding member 82b, respectively, that hold the electric wiring board. However, in the present disclosure, the first member and the second member are not limited to the first holding member 82a and the second holding member 82b. For example, both sides of the liquid discharge head 3, in particular, the electric wiring member 40 and the first electric wiring board 90a as well as the second electric wiring board 90b, may be covered with a pair of protection plates 140a and 140b as illustrated in FIG. 3B. The protection plates 140a and 140b are formed of metal or resin to protect the liquid discharge head 3 from electrical noise and mechanical pressure. Both ends of each of the protection plates 140a and 140b are supported by the first supporting portion 81a and the second supporting portion 81b. The protection plates 140a and 140b extend in the longitudinal direction. The first member and the second member may be the protection plates 140a and 140b.

In this way, a plurality of types of first and second members may be attached. In such a case, it is desirable that the linear expansion coefficient of the second channel member 60 be smaller than the linear expansion coefficient of each of the first member and the second member, in order to reduce the influence due to the difference in linear expansion coefficient between the members. If the linear expansion coefficient of the second channel member 60 is large, it may be difficult to absorb thermal expansion sufficiently with respect to the plurality of first and second members, due to the limited longitudinal size of the elongate hole 85a. If the linear expansion coefficient of the second channel member 60 is small, a change in the interval between the first supporting portion 81a and the second supporting portion 81b due to thermal expansion of the second channel member 60 can be suppressed. Accordingly, thermal expansion is easily absorbed with respect to the plurality of first and second members.

According to the present disclosure, it is possible to provide a liquid discharge head capable of forming a high-quality image by reducing the influence of a difference in linear expansion coefficient between members.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-105156, filed May 26, 2016, which is hereby incorporated by reference herein in its entirety.

What is claimed is:

1. A liquid discharge head comprising:
a recording element board including a discharge port for discharging liquid;
a channel member including a channel for supplying the liquid to the recording element board, and supporting the recording element board;
a first supporting portion fixed to the channel member on one end side of the channel member in a longitudinal direction;
a second supporting portion fixed to the channel member on another end side of the channel member in the longitudinal direction; and
a first member supported by the first supporting portion and the second supporting portion,
wherein the first supporting portion supports the first member in such a manner that the first member is movable in the longitudinal direction relative to the first supporting portion.

2. The liquid discharge head according to claim 1, wherein the recording element board is each of a plurality of recording element boards supported by the channel member along the longitudinal direction.

3. The liquid discharge head according to claim 1, wherein the second supporting portion supports the first member in such a manner that the first member is movable in the longitudinal direction relative to the second supporting portion.

4. The liquid discharge head according to claim 3, wherein the first supporting portion has a screw hole, the first member has an elongate hole having a major axis extending in the longitudinal direction, and the first supporting portion and the first member are fixed with a screw via the elongate hole.

5. The liquid discharge head according to claim 1, wherein the second supporting portion supports the first member by fixing the first member in the longitudinal direction relative to the second supporting portion.

6. The liquid discharge head according to claim 5, wherein the first member has an elongate hole having a major axis in the longitudinal direction and a round hole, the first supporting portion and the elongate hole are fixed with a screw, and the second supporting portion and the round hole are fixed with a screw.

7. The liquid discharge head according to claim 5,
wherein the first member has a first hole and a second hole,
wherein liquid discharge head has a first shoulder screw fixed to the first supporting portion through the first hole and a second shoulder screw fixed to the second supporting portion through the second hole,
wherein the first shoulder screw and the second shoulder screw each have a large diameter portion serving as a head, a threaded portion, and a small diameter portion positioned between the large diameter portion and the threaded portion, the threaded portion of the first shoulder screw and the threaded portion of the second shoulder screw are screwed into the first supporting portion and the second supporting portion, respectively, and the small diameter portion of the first shoulder screw and the small diameter portion of the second shoulder screw pass through the first hole and the second hole, respectively, and
wherein the small diameter portion of the first shoulder screw forms clearance with the first hole, and the small diameter portion of the second shoulder screw is in tight contact with the second hole.

8. The liquid discharge head according to claim 1, wherein the channel member has a linear expansion coefficient smaller than a linear expansion coefficient of the first member.

9. The liquid discharge head according to claim 1, wherein the first member is supported by the first supporting portion and the second supporting portion to be immovable in a direction orthogonal to the longitudinal direction relative to the first supporting portion and the second supporting portion.

10. The liquid discharge head according to claim 1, wherein the first member extends in the longitudinal direction within one plane, and is supported by a surface of the first supporting portion and a surface of the second supporting portion, the surfaces facing in a same direction.

11. The liquid discharge head according to claim 10, further comprising a second member supported by surfaces, of the first supporting portion and the second supporting portion, each facing a corresponding surface supporting the first member.

12. The liquid discharge head according to claim 1, wherein the first member has a first portion, a second portion, and a third portion, the first portion extends between the first supporting portion and the second supporting portion, the second portion is supported by a first surface of the first supporting portion, and the third portion, of the second supporting portion, is supported by a surface facing in a same direction as a direction in which an opposite surface of the first surface of the second supporting portion faces.

13. The liquid discharge head according to claim 1, wherein the liquid discharge head has a length of 500 mm or more in the longitudinal direction.

14. The liquid discharge head according to claim 1, further comprising:
an electric wiring board connected to the recording element board and extending in the longitudinal direction; and
a holding member holding the electric wiring board,
wherein the first member is the holding member.

15. The liquid discharge head according to claim 1, further comprising:
an electric wiring board connected to the recording element board and extending in the longitudinal direction; and
a protection plate covering the electric wiring board,
wherein the first member is the protection plate.

16. The liquid discharge head according to claim 1, further comprising:
an element configured to generate energy to be used to discharge the liquid; and
a pressure chamber including the element,
wherein the liquid in the pressure chamber circulates between the pressure chamber and outside of the pressure chamber.

17. A liquid discharge apparatus comprising:
a liquid discharge head; and
a liquid container containing liquid to be supplied to the liquid discharge head,
wherein the liquid discharge head includes:
a recording element board including a discharge port for discharging liquid;
a channel member including a channel for supplying the liquid to the recording element board, and supporting the recording element board;
a first supporting portion fixed to the channel member on one end side of the channel member in a longitudinal direction;
a second supporting portion fixed to the channel member on another end side of the channel member in the longitudinal direction; and
a first member supported by the first supporting portion and the second supporting portion,
wherein the first supporting portion supports the first member in such a manner that the first member is movable in the longitudinal direction relative to the first supporting portion.
